(19) United States
(12) Patent Application Publication
(10) Pub. No.: US 2024/0236538 A1
(43) Pub. Date: Jul. 11, 2024

(54) GAMING HEADPHONES

(71) Applicant: Bow N’ Arrow Gaming, LLC, Bingham Farms, MI (US)

(72) Inventors: Justin M. Shounia, Walled Lake, MI (US); Scott D. Rendel, Rock Hill, SC (US); Daniel B. Sharp, Edgemoor, SC (US)

(73) Assignee: Bow N' Arrow Gaming, LLC, Bingham Farms, MI (US)

(21) Appl. No.: 18/094,733

(22) Filed: Jan. 9, 2023

(51) Int. Cl. H04R 1/10; H02G 11/02

(52) U.S. Cl. CPC H04R 1/1008; H02G 11/02; H04R 1/1033

(57) ABSTRACT

Headphones comprising a first earphone having a first driver, a second earphone having a second driver, a headband connecting the first earphone to the second earphone, a cable reel system in the first earphone, and a cable are disclosed.

### TECHNICAL FIELD

The present disclosure generally relates to sound equipment, and more particularly relates to gaming headphones.

### BACKGROUND

Gaming on computers and video games consoles has grown in extreme popularity worldwide. Today, a wide variety of popular games are played such as role-playing games, action packed games, sports, fantasy, military games, and more. Gamers play at home, in public, in competitions, and online. Many gaming consoles allow its players to compete against each other, in real time, and connect over in-game experiences over the internet or online streaming. Streaming allows players to communicate with one another. To enhance the gaming experience, many players use headphones or headsets for better sound quality and for the ability to communicate with other players in the game in real time.

Headsets are headphones with microphones features that allow communication between players during gameplay. Generally, headphones are a device that includes one or two speaker assemblies, each having an audio drivers that produces audible sound. Each speaker assembly is mounted in an ear-cup housing, and a foam or other soft material is provided on the side of the ear-cup housing that will abut against the ear and/or head of a person wearing the headphone. Headphones move small amounts of air around the listeners' ears and offers an immersive sound experience as the sound source delivers a sonic play load into the ears of the user.

Generally, the electrical terminals for the audio drivers are soldered to ends of wires that extend to a jack plug extending from a cable. The cable may be connected to a video game console or computer, etc., by inserting the jack plug in a headphone jack, or the like, so that audio signal is transmitted to the audio driver in the speaker assembly within the headphone through the cable and wires. Other headphones may have an audio output jack for receiving a detachable audio cable to connect to a video game console.

Headphones may generally be over-ear headphones, on-ear headphones, or in-ear headphones/earbuds. Over-ear headphones have earphones big enough to fit over the entire human ear to engulf the ears to the sound source. On-ear headphones go over the head and rest on the ear. In-ear headphones/earbuds go inside the ear channel. Headphones may include additional features such as wireless capabilities, Bluetooth connectivity, noise-cancellation, and integrated microphones. However, many latency issues occur during video game gameplay when using wireless technology to connect the headphones to the audio source versus a direct connection such as a cable and an audio jack. Many gamers prefer to directly connect their headphones to the gaming console with an audio cable, auxiliary cord, or the like, to avoid latency issues and sound delays that occur with wireless technologies. Latency issues and sound delays can affect a gamer's performance during gameplay and reduces the overall video gaming experience.

A gamer that prefers using a direct connection must remember to bring a cable to connect their headphones to the gaming console audio source. Gamers must also remember to stow away the cable for protection. Existing headphones in the marketplace fail to provide a storage mechanism that can protect a cable for future use.

Others have attempted to design a headphone with a cord reel but fail to provide a headphone with a cable reel system within an earphone. For example, U.S. Pat. No. 6,480,611 discloses a headphone having a cord reel. The headphone requires pressing a button for releasing engaging means that controls the cord entering and exiting the earphone.

It can therefore be seen that a need exists for a headphone having an improved cable reel system without the need for an engagement locking button for winding and drawing out of a headphone.

### SUMMARY OF THE DISCLOSURE

In accordance with one aspect of the disclosure, headphones are disclosed. The headphones comprise a first earphone having a first driver, a second earphone having a second driver, a headband connecting the first earphone to the second earphone, a cable reel system in the first earphone, and a cable.

In accordance with another aspect of the disclosure, a speaker assembly is disclosed. The speaker assembly comprises an audio driver, a slip ring, a cable reel system rotatable around the electrical slip ring, and a cable.

In accordance with another aspect of the disclosure, a method of providing a cable in a headset is disclosed. The method comprises: providing the headset having a first earphone, a second earphone, a headband, a cable, and a microphone, the first earphone having a cable reel system including a ratchet mechanism, a spool for storing the cable, and an electrical slip ring; pulling the cable so the spool rotates and ratchets past a locking sector having a plurality of notches; and setting the cable at a desired length wherein a ratchet engages one of the plurality of notches and terminate recoiling by the cable reel system.

These and other aspects and features of the present disclosure will be better understood upon reading the following detailed description when read in conjunction with the accompanying drawings.

### BRIEF DESCRIPTION OF THE DRAWINGS

FIG. 1 is a perspective view of a headphone, according to an embodiment of the present disclosure.

FIG. 2 is a font view of a headphone, according to an embodiment of the present disclosure.

FIG. 3 is a side view of the headphone of FIG. 2, according to an embodiment of the present disclosure.

FIG. 4 is a cross-section of the headphone of FIG. 2 taken along the 4-4 line of FIG. 3, according to an embodiment of the present disclosure.

FIG. 5 is a perspective view of an earphone of the headphone of FIG. 1 comprising a cable reel system, according to an embodiment of the present disclosure.

FIG. 6 is an exploded view of the earphone of FIG. 5, according to an embodiment of the present disclosure.

FIG. 7 is a front view of a ratchet mechanism of the cable reel system of the earphone of FIG. 5, according to an embodiment of the present disclosure.

FIG. 8 is a front view of the driver assembled to the cable reel system of the earphone of FIG. 5, according to an embodiment of the present disclosure.

FIG. 9 is a perspective view of an electrical slip ring, according to an embodiment of the present disclosure.

The figures depict one embodiment of the presented invention for purposes of illustration only. One skilled in the art will readily recognize from the following discussion that alternative embodiments of the structures and methods illustrated herein may be employed without departing from the principles described herein.

### DETAILED DESCRIPTION

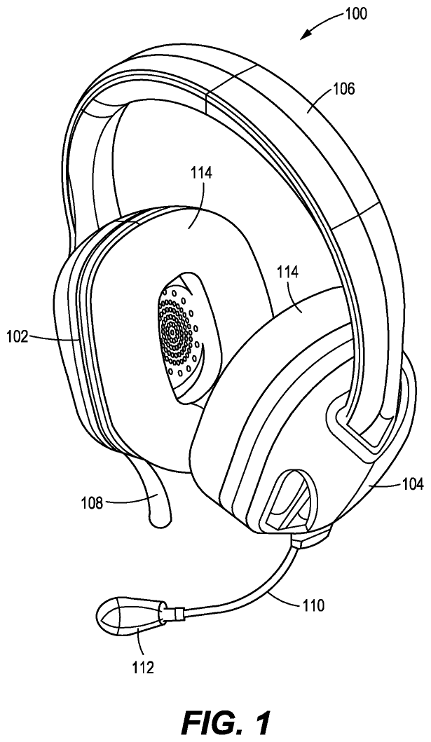

Referring now to the drawings, and with specific reference to the depicted example, headphones 100 are shown as an exemplary disclosure. Now referring to FIGS. 1-3, the headphones 100 are disclosed in one illustrated embodiment as a headset. The headphones 100 comprise a first earphone 102, a second earphone 104, and a headband 106 connecting the first earphone 102 the second earphone 104.

The headphones 100 includes a cable 108 connected to the first earphone 102 capable of extending in and out of the first earphone 102. The cable 108 may be an input cable, audio cable, auxiliary cable, or other similar cable used for video or computer gaming, or the like.

The second earphone 104 may further comprise a mic boom 110 connected to a microphone 112. The microphone 112 is capable to receive audio for communication between players during gameplay while connected online or via streaming, as generally known in the arts. The first earphone 102 and the second earphone 104 may each have earpads 114 for comfort during extended gaming sessions. The earpads 114 may be removable and made of various materials for comfort ranging from natural to synthetic material.

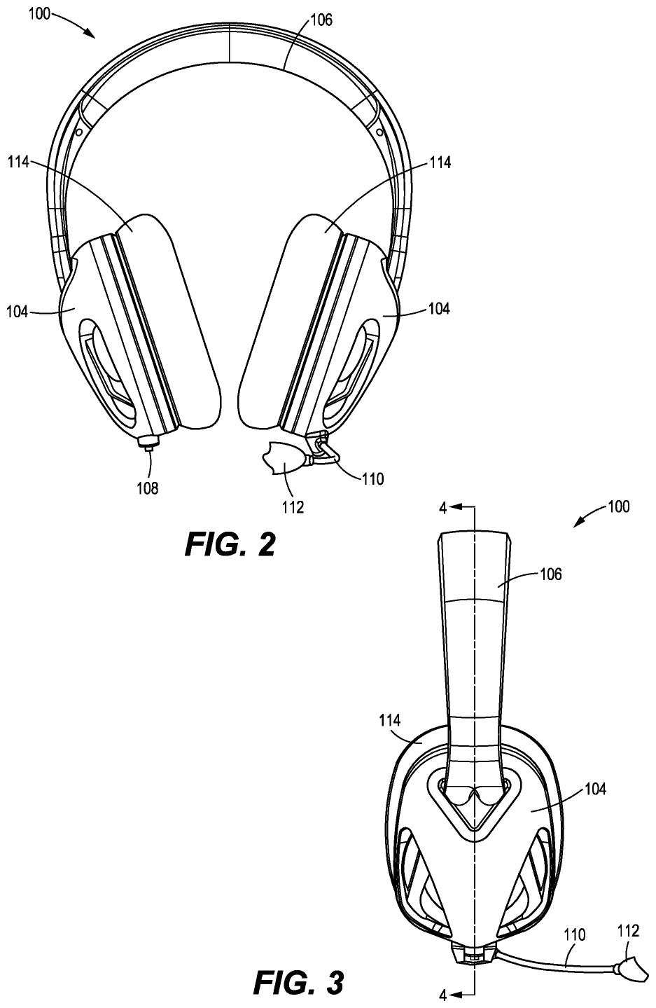

As shown in FIG. 2, the first earphone 102 may have a cable exit 200 for the cable to extend out of the headphones 100. FIG. 2 shows a portion of the cable 108 without any connectors on a first end 202 of the cable 108 which exits the first earphone 102 via the cable exit 200. The cable exit 200 may be made out of low friction material such as rubber plastic, projection molded products, or the like. The cable 108 may be drawn out of the first earphone 102 from the cable exit 200.

The cable 108 may have a connector (not shown) or “audio jack” on the first end 202, through which an audio signal (e.g., an analog audio signal or digital audio signal) is transmittable and through which the connector is used to structurally and electrically connect components of an audio system to one another. Audio jacks may be male or female connectors (e.g., plugs or sockets) and may include tip, ring, sleeve (TRS) connectors; tip, sleeve (TS) connectors; tip, ring, ring, sleeve (TRRS) connectors; stereo plugs; mini-jacks; mini-stereo connectors; headphone jacks; and Bantam plugs. The connector or audio jack may be connected or coupled to a media player or audio source such as a video game console, tablet, phone, a computer, a television, Xbox®, PlayStation®, etc., and the audio signal is transmitted to the first earphone 102 and the second earphone 104 within the headphones 100 as well as receiving audio signal from the microphone 112.

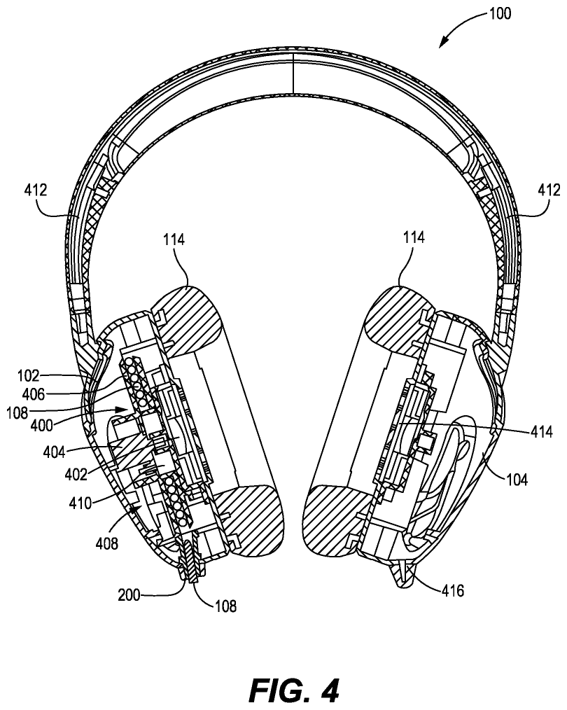

Now referring to FIG. 4, a cross-section of the headphones 100 taken along the 4-4 line of FIG. 3 is illustrated, according to one embodiment of the disclosure. The first earphone 102 comprises the cable 108, a cable reel system 400, a first driver 402, and a slip ring 404.

The cable reel system 400 is configured to retract the cable 108 into the first earphone 102. The cable 108 may be drawn out of the first earphone 102 when a user pulls the cable 108 out from the first earphone 102. The cable reel system 400 allows for the cable 108 to remain attached to the headphones 100 for storage, easier transportation, prevention of loss, and easy accessibility.

The cable reel system 400 includes a spool 406, a ratchet mechanism 408, and a spool biasing member 410. The spool 406 stores the cable 108 by winding the cable 108 into the first earphone 102. The biasing force of the spool biasing member 410 causes the winding and retracting of the cable 108 into the first earphone 102. The ratchet mechanism 408 allows a user to draw the cable 108 out from the first earphone 102 to a desired length and maintain that length during gameplay. After a user is completing with playing, a subsequent pull of the cable 108 will cause the ratchet mechanism 408 to recoil the cable 108 back into the first earphone 102, or to a desired shorter length.

The ratchet mechanism 408 is attached to the spool 406 and controls the winding, retracting, and release of the cable 108 in and out of spool 406. The ratchet mechanism 408 may be released upon a slight pull of the cable 108 outside the first earphone 102 to release the ratchet mechanism 408 from a locked state to a released state. A subsequent pull of the cable 108 causes the ratchet mechanism 408 to cause the spool 406 to recoil and wind the cable 108 into the spool 406 and inside the first earphone 102. The spool biasing member 410, such as a spring, or the like, provides a biasing force that winds or recoils the cable 108 into the spool 406. The spool biasing member 410 provides a biasing force that causes the spool 406 to rotate in a direction that winds and retracts the cable 108 into the spool 406 and into the first earphone 102.

The headband 106 may comprise adjustable length features 412, as generally known in the arts. The headband 106 may be configured to position the first earphone 102 and the second earphone 104 attached to the headband 106 over, on, or proximate a user's ears such that sound from the first earphone 102 and the second earphone 104 can be more easily heard by the user.

The second earphone 104 may include a second driver 414 and a mic port 416 for the mic boom 110 and microphone 112. It may be recognized that the microphone 112 on the second earphone 104 may be in the first earphone 102, or otherwise installed on the headphones 100. The first driver 402 and the second driver 414 may be speakers, as generally known in the arts. For example, the first driver 402 and the second driver 414 may be 40 mm drivers, 45 mm drivers, or the like.

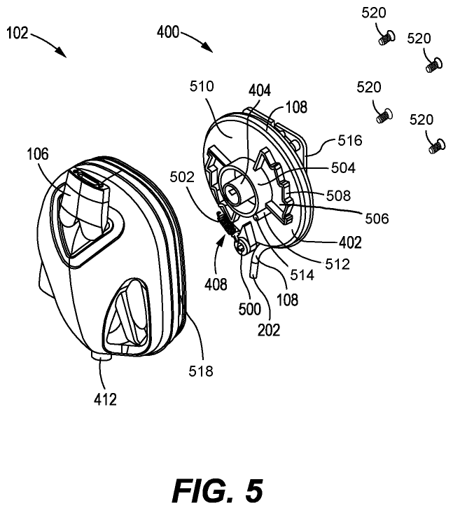

Now referring to FIG. 5, a perspective view of the first earphone 102 is illustrated. The cable reel system 400 is shown with the cable 108 recoiled and wound into the spool 406. The ratchet mechanism 408 is attached to the spool 406 and rotates in the same direction as the spool 406.

The ratchet mechanism 408 includes a ratchet 500, a ratchet biasing member 502, and a locking mechanism 504. The locking mechanism 504 may be a ring-shaped body and configured to be rotatable around the slip ring 404. The locking mechanism 504 includes locking sectors 506 extending from the ring-shaped body to approximately the perimeter of the spool 406. The locking sectors 506 may comprise a plurality of notches 508 configured to engage with the ratchet 500. The locking mechanism 504 may be mounted or attached to the spool 406 and rotatable around the slip ring 404 in unison with the spool 406.

The locking mechanism 504 may form non-locking areas 510 between each of the locking sectors 506 when the locking mechanism 504 is attached to the spool 406. The space formed between each of the locking sectors 506 forms the non-locking areas 510 of the locking mechanism 504. The non-locking areas 510 allows the cable to more easily and quickly be unwound from the spool 406 and drawn out of the first earphone 102, and vice versa.

The ratchet 500 is positioned approximately along the perimeter of the spool 406 so that it engages with one of the plurality of notches 508 of the locking sectors 506 as the spool 406 rotates. The ratchet biasing member 502, such as a spring, provides a biasing force against the ratchet 500 to keep the ratchet 500 engaged against one of the plurality of notches 508. At a certain threshold, a pull on the cable 108 will overcome the biasing force of the ratchet biasing member 502. The ratchet 500 also helps prevent the spool 406 from recoiling and winding the cable 108 back into the first earphone 102 by maintaining engagement against one of the plurality of notches 508 until a certain threshold by a subsequent pull of the cable 108, whereby the cable 108 is slightly drawn out to release the engagement of the ratchet 500 on the plurality of notches 508 and allow the spool 406 to recoil and wind the cable into the spool 406 in the first earphone 102. When a user pulls the cable 108 at a certain threshold, the spool 406 will rotate so that the engaged locking sector 506 will move past the ratchet 500 and the cable 108 will be in a released state to be drawn out of the cable exit 200 for a desired length.

The spool 406 may include a slot 512 for a second end 514 of the cable 108 to exit the spool 406, within the first earphone 102, and connect to the slip ring 404. The slot 512 provides the cable 108 access to connect to the electrical wiring of the electrical slip ring 404. The second end 514 may be soldered to the electrical wirings of the slip ring 404, or otherwise electrically connected as generally known in the arts.

The slip ring 404 is electrical connected to the first driver 402 and provides the first driver 402 with electrical connection. The slip ring 404 maintains electrical connections in the headphones 100 while the cable 108 retracts in and out of the first earphone 102. The slip ring 404 allows for the electrical wiring to avoid tangling when the cable 108 is wound in and out of the first earphone 102 when operating the cable reel system 400. When operating the cable reel system 400, the cable reel system 400 rotates around the slip ring 404.

A bracket 516 is provided to integrate the cable reel system 400 to an earphone housing 518 of the first earphone 102. The bracket 516 may be integrated to the earphone housing 518 with bolts 520, or the like, that maintains the components of the first earphone 102 assembled for normal operation.

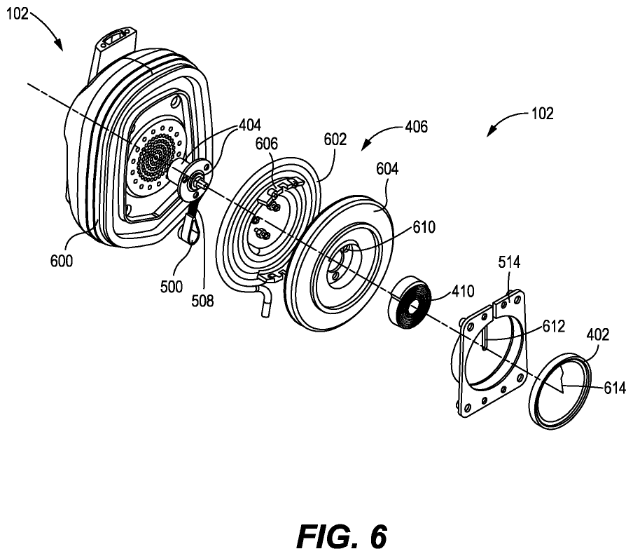

Now referring to FIG. 6, an exploded view of the first earphone 102 is illustrated. The cable reel system 400, the slip ring 404, and the first driver 402 are assembled within an earphone housing 600 of the first earphone 102. The ratchet 500 is connected to the ratchet biasing member 502 which is connected to the earphone housing 600 to maintain a biasing force against the ratchet 500 when engaging the locking sectors 506 of the locking mechanism 504. The biasing force provided against the ratchet 500 by the ratchet biasing member 502 prevents the spool 406 from rotating when engaging the locking sectors 506 until the cable 108 is pulled at a certain pull threshold that overcomes the biasing force.

The spool 406 includes a first spool end 602, a second spool end 604, and a retaining clip 606. The spool 406 may also have a spool core 610. The retaining clip 606 may be integrated on the first spool end 602 and configured to attach to the second spool end 604. The retaining clip may be attached on the interior side of the first spool end 602. The second spool end 604 may remain in place as the spool 406 rotates. The first spool end 602 may rotate as the cable 108 is pulled and wound in the first earphone 102.

The first spool end 602 may attach to the ratchet mechanism 408 and ratchet 500. The locking sectors 506 are rotatable with the first spool end 602. The non-locking areas 510 are formed by the open space between adjacent locking sectors 506 when the ratchet mechanism 408 is attached to the exterior of the spool 406 on the first spool end 602. As the first spool end 602 rotates, the locking mechanism 504 rotates and engages the ratchet 500. The spool biasing member 410 may be integrated within the spool core 610 of the spool 406 provides a biasing force or retraction force from within the spool core 610. It may be recognized in FIG. 6 that the spool 406, the spool core 610, and spool biasing member 410 may maintain a hollow core to allow the slip ring 404 access to connect its electrical wirings to the first driver 402. The access may be provided in the center of the first earphone 102, concentric with the cable reel system 400 without electrical wires of the slip ring 404 and the cable 108 tangling.

The bracket 516 is provided to integrate the cable reel system 400 to an earphone housing 518 of the first earphone 102. The bracket 516 may be integrated to the earphone housing 518 with bolts 520, or the like, that maintains the components of the first earphone 102 assembled for normal operation. The bracket 516 may include an electrical slot 612 for electrical wiring connection and protection, as generally known in the arts.

The first driver 402 integrates with the bracket 516 to provide audible sound to a user of the headphones 100. The first driver 402 and the second driver 414 may each be audio drivers that produces audible sound that use a magnet, coil, and diaphragm as generally known in the arts. The first driver 402 may be a 40 mm driver. The first driver 402 connects to the slip ring 404 via the driver wiring 614 which may access the electrical slot 612 of the bracket 516.

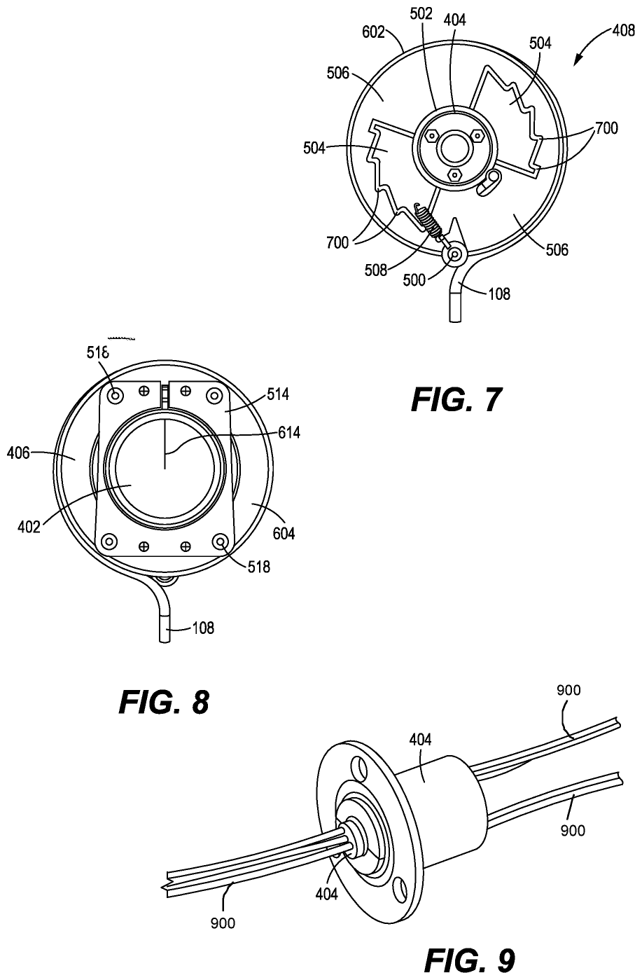

Now referring to FIGS. 7-8, the sides of the spool 406 are illustrated connected to the ratchet mechanism 408 and the bracket 516, respectively, in one embodiment of the disclosure. FIG. 7 illustrates the ratchet mechanism 408 attached to the first spool end 602. FIG. 8 illustrates the second spool end 604 of the spool 406 assembled to the bracket 516.

Now referring to FIG. 9, the slip ring 404 is illustrated according to one embodiment of the disclosure. The slip ring 404 may include a plurality of wires 900. The Electrical Slip Ring may be a Comidox 12.5 mm 300 Rpm 6 Wires CIRCUITSx2A Capsule Electrical Slip Ring. The audio signals are provided to the headphones 100 when the first end 202 of the cable 108 is connected to a power source such as a video game console. In one embodiment the slip ring 404 may include four electrical wires. The slip ring 404 may be provided with a ground wire, a first speaker wire, a second speaker wire, and a microphone wire. The ground wire may extend through the slip ring 404, splits and goes to both the first earphone 102 and the second earphone 104 and the mic. The first speaker wire goes through the slip ring 404 and to the first earphone 102. The second speaker wire goes through the slip ring 404 and to the second earphone 104. The microphone wire goes through the slip ring 404 and to the second earphone 104.

The ratchet mechanism 408 may be spread evenly over the whole rotation of the first spool end 602. For example, 25% of the rotation of the spool 406 may be locking sectors 506 of the ratchet mechanism 408 and then the non-locking areas 510, which may be open space between adjacent locking sectors 506. When the cable 108 is pulled, a plurality of clicks may be recognized by a user as the ratchet 500 hits the notches 508 on the locking sectors 506 of the locking mechanism 504 by the “ratcheting.” The ratcheting provides a user a user the ability to feel the ratcheting of the ratchet 500 against the notches 508 and stop the cable 108 at a desired length. If the cable 108 is pulled past one of the notches 508 of one of the locking sectors 506, the user will feel an area that is loose as the ratchet 500 is in one of the non-locking areas 510. If the cable 108 is released while in one of the non-locking areas 510, then the cable 108 will recoil into the spool 406 caused by the biasing force of the spool biasing member 410 which powers the retraction and rotation of the spool 406. When the ratchet 500 clicks against one of the notches 508, then the cable 108 may be held to the desired length as the ratchet biasing member 502 provides a counter biasing force to the spool biasing member 410 to maintain the ratchet 500 engaged against the notches 508 and prevent retraction of the cable 108. The electrical wires in the slip ring 404 enter and exit the front and back of the slip ring 404 to allow the cable 108 to be wound around the slip ring 404 without getting the electrical wirings of the cable 108 tangled with the electrical wires in the slip ring 404.

### INDUSTRIAL APPLICABILITY

In operation, the present disclosure may find applicability in many industries including, but not limited to, the computer gaming, video gaming, and electronics industries. Specifically, the technology of the present disclosure may be used to receive and transmit audio in a variety of headphones including, but not limited to, over-ear headphones, on-ear headphones, in-ear headphones, headsets, speakers, and the like. While the foregoing detailed description is made with specific reference to headsets, it is to be understood that its teachings may also be applied onto the other headphones, speakers, speakers with a microphone, audio drivers, and the like.

As can be seen by the present disclosure, a method of stowing the cable 108 in a headphone 100 is disclosed. The method comprises providing the headphone 100 with the first earphone 102, the second earphone 104, the headband 106, the cable 108, and the microphone 112, the first earphone 102 having the cable reel system 400 including the ratchet mechanism 408, the spool 406 for storing the cable 108, and the slip ring 404 for protecting the electrical wiring connections. The cable reel system 400 is configured to rotate around the slip ring 404 to prevent tangling of the cable 108 and the plurality of electrical wires 900.

The method further comprises pulling the cable 108 so the spool 406 rotates and ratchets past the locking sectors 506 and the plurality of notches 508; and setting the cable 108 at a desired length so that the ratchet 500 engages one of the plurality of notches 508 and terminate the recoiling by the spool biasing member 410 of the cable reel system 400. The ratchet 500 maintains its engagement against the plurality of notches 508 because the ratchet biasing member 502 provides a sufficient force so the locking sectors 506 are prevented from rotating thereby preventing the spool 406 from rotating and releasing the cable 108 from the first earphone 120. The cable 108 may be drawn out and set at its entire length. The cable 108 may be pulled until the ratchet 500 is released from engagement against the plurality of notches 508. The cable 108 may then be released so that the cable reel system 400 recoils the cable 108 into the first earphone 102. The recoiling may occur when the ratchet 500 is in one of the non-locking areas 510 when the cable 108 is released.

From the foregoing, it can be seen that the technology disclosed herein has industrial applicability in a variety of settings such as, but not limited to headphones including, but not limited to, over-ear headphones, on-ear headphones, in-ear headphones, headsets, speakers, and the like for gaming, video gaming, entertainment, music listening, internet collaboration and communication.

What is claimed is:

1. Headphones comprising:
a first earphone having a first driver, a second earphone having a second driver, a headband connecting the first earphone to the second earphone, a cable reel system in the first earphone, and a cable.

2. The headphones of claim 1, further comprising an electrical slip ring wherein the cable reel system rotates around the electrical slip ring.

3. The headphones of claim 2, the cable reel system includes a cable spool for storing the cable, a spool biasing member, a ratchet, a ratchet biasing member, and a locking mechanism that engages the ratchet.

4. The headphones of claim 2, further comprising a microphone.

5. The headphones of claim 4, wherein the cable has a first end for connecting to a video game console and a second end electrically connected to the electrical slip ring, and the electrical slip ring provides electrical connection to the first earphone, the second earphone, and the microphone.

6. The headphones of claim 1, the cable is one chosen from the group consisting of an audio cable, input cable, and an auxiliary cord.

7. The headphones of claim 6, the cable is at least 3 feet long and has a diameter of at least 3.5 mm.

8. The headphones of claim 6, the cable is flat or round.

9. The headphones of claim 1, the headphones further comprising adjustable length features in the headband, and removable earpads on the first earphone and the second earphone.

10. A speaker assembly comprising:
an audio driver, a slip ring, a cable reel system rotatable around the electrical slip ring, and a cable.

11. The speaker assembly of claim 10, the cable reel system includes a spool for winding the cable, a spool biasing member, and a ratchet mechanism attached to the spool, the ratchet mechanism including a locking mechanism, a ratchet, and a ratchet biasing member.

12. The speaker assembly of claim 11, further comprising a microphone.

13. The speaker assembly of claim 12, the cable having a first end for connecting to a video game console and a second end electrically connected to the slip ring, and the slip ring provides electrical connection to the audio drier and the microphone.

14. The speaker assembly of claim 13, the slip ring is an electrical slip ring having a plurality of electrical wire connections for connecting the second end of the cable to the audio driver and microphone.

15. The speaker assembly of claim 10, the cable is one chosen from the group consisting of an audio cable, input cable, and an auxiliary cord.

16. The speaker assembly of claim 15, the cable is at least 3 feet long and has a diameter of at least 3.5 mm.

17. The speaker assembly of claim 15, the cable is flat or round.

18. The speaker assembly of claim 10, the spool biasing member and ratchet biasing member are one chosen from the group consisting of a spring, helical spring, spiral wound spring, torsion spring, compression spring.

19. A method of providing a cable in a headset, the method comprising:
providing the headset having a first earphone, a second earphone, a headband, a cable, and a microphone, the first earphone having a cable reel system including a ratchet mechanism, a spool for storing the cable, and an electrical slip ring;
pulling the cable so the spool rotates and ratchets past a locking sector having a plurality of notches; and
setting the cable at a desired length wherein a ratchet engages one of the plurality of notches and terminate recoiling by the cable reel system.

20. The method of claim 17 further comprising:
pulling the cable until the ratchet is released from engagement against the plurality of notches;
releasing the cable so that the cable reel system recoils the cable into the first earphone.
